(19) United States
(12) Patent Application Publication
(10) Pub. No.: US 2015/0124047 A1
(43) Pub. Date: May 7, 2015

(54) PANORAMIC VIDEO ACQUISITION GUIDANCE

(71) Applicants: Liron YATZIV, Sunnyvale, CA (US); Abhijit Ogale, Mountain View, CA (US); Gadi Royz, San Francisco, CA (US); Rony Amira, Rishon Lesion (IL); Yossi Matias, Tel Aviv (IL); Misha Seltzer, Kfar Saba (IL)

(72) Inventors: Liron YATZIV, Sunnyvale, CA (US); Abhijit Ogale, Mountain View, CA (US); Gadi Royz, San Francisco, CA (US); Rony Amira, Rishon Lesion (IL); Yossi Matias, Tel Aviv (IL); Misha Seltzer, Kfar Saba (IL)

(73) Assignee: GOOGLE Inc., Mountain View, CA (US)

(21) Appl. No.: 13/553,991

(22) Filed: Jul. 20, 2012

(51) Int. Cl. H04N 5/232; H04N 7/00

(52) U.S. Cl. CPC H04N 5/23222; H04N 5/23238
USPC 348/37; 348/36; 348/E07.001

(57) ABSTRACT

Panoramic video acquisition guidance is automatically provided as feedback during panoramic video capture. Commensurate with receiving a panoramic video being captured, at least one panoramic video acquisition guidance indicator is provided. This panoramic video guidance acquisition indicator(s) provides real-time acquisition feedback on the panoramic video being captured, and is based, at least in part, on the panoramic video being captured or movement of a video capture device capturing the panoramic video. In one or more implementations, the panoramic video guidance indicator may include a video rotation progress indicator, a video tilt or video pitch indicator, and/or a video rotation speed indicator.

### BACKGROUND

A video capture device, such as a pocket video camera or cell phone video camera, can be employed to capture panoramic video. In particular, panoramic video can be captured by an operator turning the video capture device any number of degrees while capturing video. Today, a video capture device is often embodied as a digital camera incorporated, for example, directly into computer communications hardware, such as provided within, for instance, a mobile phone.

More particularly, panoramic video is obtained by an operator or user of a video capture device rotating the video capture device a certain number of degrees, for example, between zero and 360°, or more than 360°, while recording or capturing video. In one example, capturing panoramic-based video may involve recording video, while rotating the video capture device 360°. When doing so, video capture or recording issues can arise. For example, a panoramic video recording could be terminated before completing a full 360° rotation (that is, in those cases where (for instance) a 360° panoramic video is desired), tilt and/or pitch changes relative to (for example) an initial video frame of the recording may occur, such that upon reaching a full 360° rotation the frames do not overlap well, and/or rotation of video capture device may be too quick, resulting (for example) in blurrying of the captured video.

### BRIEF SUMMARY

The shortcomings of the prior art are overcome and additional advantages are provided through the provision, in one embodiment, of a method which includes: receiving a panoramic video being captured; and providing at least one panoramic video acquisition guidance indicator, the at least one panoramic video acquisition guidance indicator including feedback on the panoramic video being captured and being based, at least in part, on the panoramic video being captured or movement of a video capture device capturing the panoramic video.

In a further aspect, a method is provided which includes: receiving panoramic video being captured; providing, based at least in part on the panoramic video being captured or movement of a video capture device capturing the panoramic video, at least one panoramic video acquisition guidance indicator commensurate with capturing of the panoramic video, the at least one panoramic video acquisition guidance indicator providing feedback on the panoramic video being captured; and wherein the at least one panoramic video acquisition guidance indicator includes at least one of a video rotation progress indicator, a video tilt or video pitch indicator, or a video rotation speed indicator.

In another aspect, a system is provided which includes a video capture device, and a panoramic video acquisition guidance component. The panoramic video acquisition guidance component is associated with the video capture device and provides at least one panoramic video acquisition guidance indicator based, at least in part, on a panoramic video being captured by the video capture device or movement of the video capture device during capturing of the panoramic video. The at least one panoramic video acquisition guidance indicator provides panoramic video acquisition guidance on the panoramic video being captured.

In yet another aspect, a system is provided which includes a video capture device, and a panoramic video acquisition guidance component associated with the video capture device. The panoramic video acquisition guidance component provides at least one panoramic video acquisition guidance indicator based, at least in part on, and commensurate with, capturing of a panoramic video via the video capture device. The at least one panoramic video acquisition guidance indicator includes panoramic video acquisition guidance on the panoramic video being captured, and includes at least one of a video rotation progress indicator, a video tilt or video pitch indicator, or a video rotation speed indicator.

In a further aspect, a computer program product for guiding panoramic video acquisition is provided. The computer program product includes a computer-readable storage medium readable by a processor and storing instructions for execution by the processor for performing a method which includes: receiving a panoramic video being captured; and providing at least one panoramic video acquisition guidance indicator. The at least one panoramic video acquisition guidance indicator provides acquisition feedback on the panoramic video being captured, and is based, at least in part, on the panoramic video being captured or movement of a video capture device capturing the panoramic video.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1A is an exemplary diagram of a panoramic video capture, for which panoramic video acquisition guidance may be provided, in accordance with one or more aspects of the present invention;

FIG. 1B is an exemplary diagram of video capture device height and a pitch angle during panoramic video capture, for which panoramic video acquisition guidance may be provided, in accordance with one or more aspects of the present invention;

FIG. 1C is an exemplary diagram of a video capture device during panoramic video capture, and illustrating device height and a tilt angle for which panoramic video acquisition guidance may be provided, in accordance with one or more aspects of the present invention;

FIG. 2 is a conceptual diagram of one embodiment of a video capture device with panoramic video acquisition guidance, in accordance with one or more aspects of the present invention;

FIG. 3A is a flowchart depicting one embodiment of a video rotation progress module, in accordance with one or more aspects of the present invention;

FIG. 3B is an exemplary diagram of a video capture device during panoramic video capture, with one embodiment of a real-time, video rotation progress indicator illustrated, in accordance with one or more aspects of the present invention;

FIG. 3C is an exemplary diagram of a video capture device of during panoramic video capture, with another embodiment of a real-time, video rotation progress indicator illustrated, in accordance with one or more aspects of the present invention;

FIG. 3D is an exemplary diagram of a video capture device during panoramic video capture, with an alternate embodiment of a real-time, video rotation progress indicator illustrated, in accordance with one or more aspects of the present invention;

FIG. 3E is an exemplary diagram of a video capture device during panoramic video capture, with an audio-based, real-time video rotation progress indicator illustrated, in accordance with one or more aspects of the present invention;

FIG. 3F is an exemplary diagram of a video capture device during panoramic video capture, with a further embodiment of a real-time, video rotation progress indicator illustrated, in accordance with one or more aspects of the present invention;

FIG. 4A is a flowchart of one embodiment of a video tilt and/or pitch status module, in accordance with one or more aspects of the present invention;

FIG. 4B is an exemplary diagram of a video capture device during panoramic video capture, with one embodiment of an initial tilt and pitch guidance overlay illustrated, in accordance with one or more aspects of the present invention;

FIG. 4C is an exemplary diagram of a video capture device during panoramic video capture, with one embodiment of a real-time tilt and pitch indicator illustrated, in accordance with one or more aspects of the present invention;

FIG. 4D is an exemplary diagram of a video capture device during panoramic video capture, with an alternate embodiment of a real-time tilt indicator illustrated, in accordance with one or more aspects of the present invention;

FIG. 4E is an exemplary diagram of a video capture device during panoramic video capture, with a further embodiment of a real-time pitch indicator illustrated, in accordance with one or more aspects of the present invention;

FIG. 4F is an exemplary diagram of a video capture device during panoramic video capture, with a further embodiment of a real-time tilt and pitch indicator depicted, in accordance with one or more aspects of the present invention;

FIG. 4G is an exemplary diagram of a video capture device during panoramic video capture, with another embodiment of a real-time tilt indicator and a real-time pitch indicator depicted, in accordance with one or more aspects of the present invention;

FIG. 5A is a flowchart of one embodiment of a video rotation speed module, in accordance with one or more aspects of the present invention;

FIG. 5B is an exemplary diagram of a video capture device during panoramic video capture, with one embodiment of a video rotation speed indicator illustrated, in accordance with one or more aspects of the present invention;

FIG. 5C is an exemplary diagram of a video capture device during panoramic video capture, with another embodiment of a video rotation speed indicator illustrated, in accordance with one or more aspects of the present invention;

FIG. 5D is an exemplary diagram of a video capture device during panoramic video capture, with a further embodiment of a video rotation speed indicator illustrated, in accordance with one or more aspects of the present invention; and

FIG. 6 is an exemplary block diagram of one embodiment of a computer system comprising a video capture device, with which one or more aspects of the present invention may be implemented.

### DETAILED DESCRIPTION

Aspects of the present invention and certain features, advantages and details thereof are explained more fully below with reference to the non-limiting embodiments illustrated in the accompanying drawings. Descriptions of well-known components, equipment, processing techniques, etc., are omitted so as not to unnecessarily obscure the invention in detail. It should be understood, however, that the detailed description and the specific examples, while indicating embodiments of the invention, are given by way of illustration only, and are not by way of limitation. Various substitutions, modifications, additions and/or arrangements within the spirit and/or scope of the underlying inventive concepts will be apparent to those skilled in the art from this disclosure.

As used herein, a “video capture device” refers to a device, apparatus, system, subsystem, component, module, etc., designed for or capable of capturing a video, with a pocket video camera or cell phone video camera being two examples of a video capture device. A panoramic video refers to a video being captured wherein the video capture device is rotated during the video capture any desired number of degrees from, for example, an initial orientation. As an example, a panoramic video may comprise video that is captured during a 90° rotation, 180° rotation, 360° rotation, or (for example) any degree rotation between zero and 360°. Still further, panoramic video may comprise video captured in any arcing or curving manner outside of a perfect 360° circle, or may comprise video captured beyond 360°, such as 720°, 1080°, etc. In addition, note that as used herein, the term “video” refers to, by way example, a moving visual image irrespective of any rotation of the video capture device, and in one implementation, comprises a sequence of images or frames, such as 30 frames per second video, representing scenes in motion.

Reference is made below to the drawings (which are not drawn to scale for ease of understanding), wherein the same reference numbers used throughout different figures designate the same or similar components.

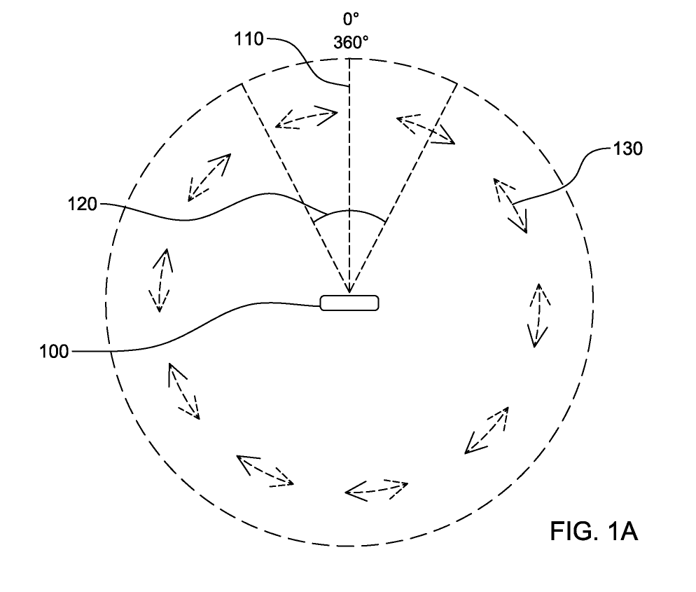

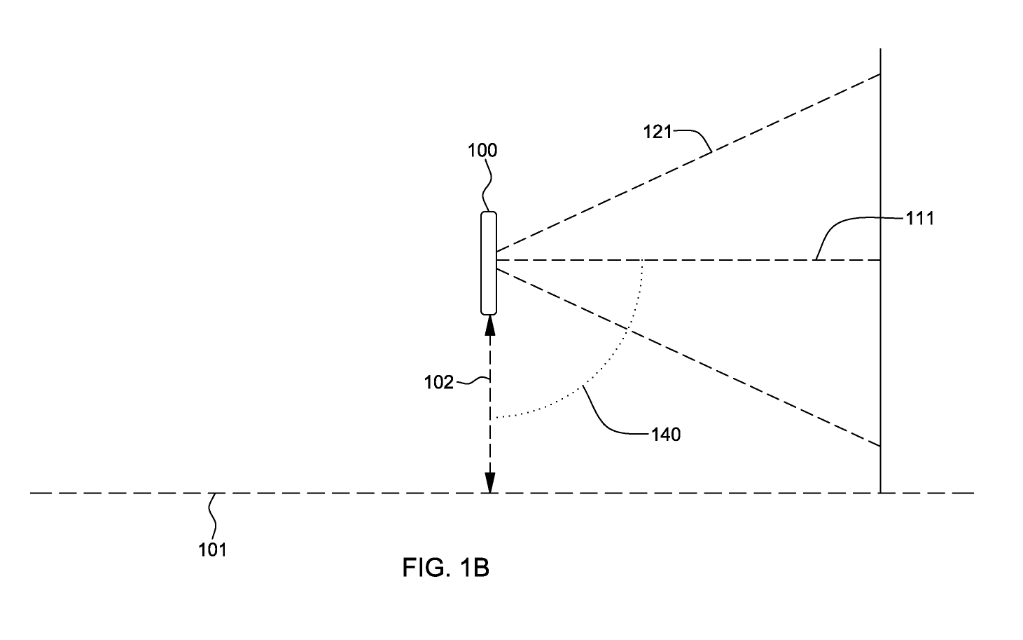

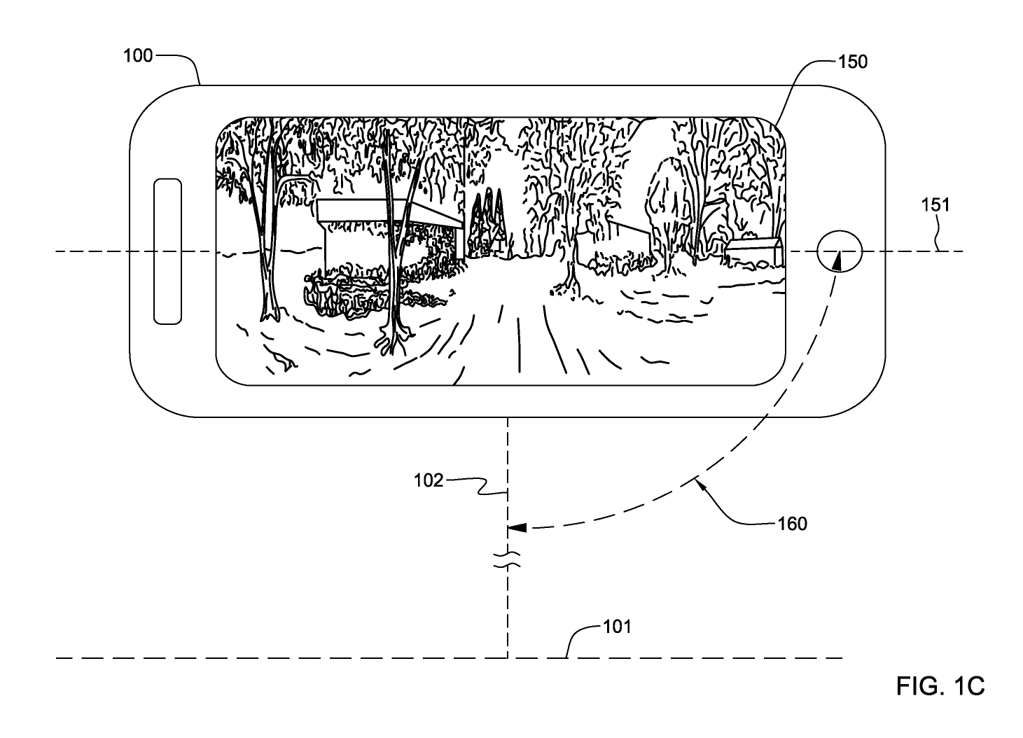

FIG. 1A depicts in plan view one example of a panoramic video capture. In this example, a video capture device 100 is illustrated having a horizontal video capture center line 110 within a horizontal video capture field of view 120. Panoramic video is obtained by capturing video while rotating the video capture device 100, for instance, a desired degree of rotation between zero and 360°, either clockwise or counterclockwise 130. Issues may arise during such panoramic video capture, particularly in the case (for instance) where a 360° panoramic video is desired. In such a case, a panoramic video recording could be prematurely terminated by the user before completing the desired, 360° rotation.

In FIG. 1B, a side elevational view of one embodiment of video capture device 100 is illustrated, wherein the video capture device is depicted at a height above a ground or floor 101, and a pitch angle 140 is defined as the angle between a vertical video capture center line 111 (of a vertical video capture field of view 121) and a vertical height line 102 extending between video capture device 100 and ground or floor 101. FIG. 1C illustrates a tilt angle 160 defined between vertical height line 102 (extending between video capture device 100 and ground or floor 101) and a horizontal axis line 151 through the video in video display 150 of video capture device 100. Pitch and tilt can be significant in, for example, 360° panoramic video acquisition. In such cases, upon reaching a full 360° rotation, it may be desirable for the ending tilt and pitch to align to the beginning tilt and pitch in order that the initial frame and ending frame overlap well.

As another consideration, the speed with which the video capture device is rotated during panoramic video capture may be an issue. For example, rotating a video capture device too quickly during panoramic video capture can result in blurrying of the captured video.

In view of these issues, disclosed herein is the concept of panoramic video acquisition guidance that is provided in real-time during panoramic video capture to, for example, improve quality of the final video panorama. The panoramic video acquisition guidance may be provided via one or more panoramic video acquisition guidance indicators. These panoramic video acquisition guidance indicators are particularly applicable to, for example, a mobile video capture device, such as a video camera within a mobile phone.

Generally stated, a method, system and computer program product are disclosed herein for providing panoramic video acquisition guidance. The method includes obtaining or receiving a panoramic video being captured, and providing one or more panoramic video acquisition guidance indicators. The one or more panoramic video guidance acquisition indicators provide acquisition feedback or guidance on the panoramic video being captured, for example, to facilitate improving quality of the final video panorama, and are provided in real-time, that is, concurrent or commensurate with capturing of the panoramic video. As explained below, and by way of example only, the panoramic video guidance indicator(s) may comprise one or more of a video rotation progress indicator, a video tilt or video pitch indicator, or a video rotation speed indicator.

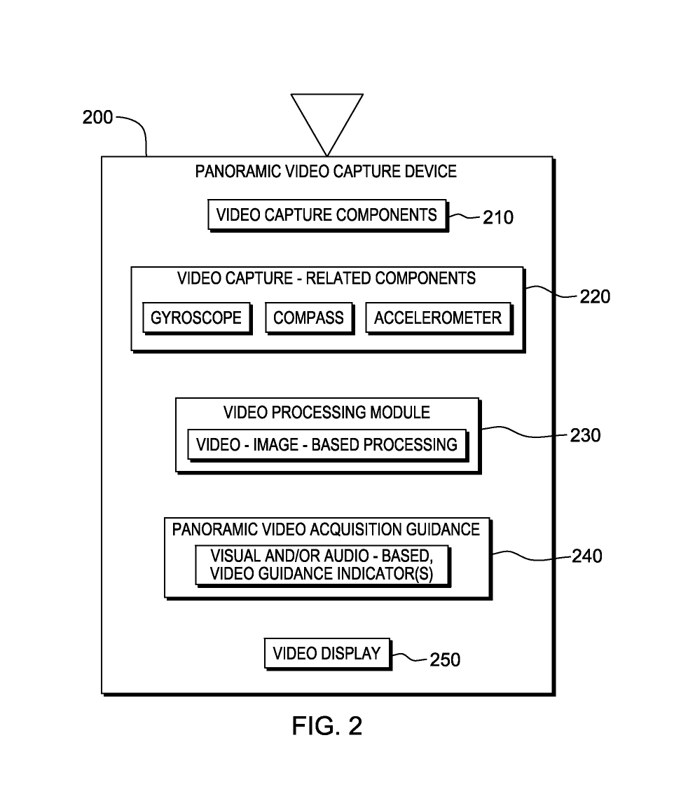

By way of example, FIG. 2 depicts one conceptual embodiment of a panoramic video capture device 200, which includes video capture components 210, such as conventional video camera components, video capture related components 220 (which may optionally include gyroscope hardware, compass hardware, and/or accelerometer hardware), a video processing module 230, which may include video image-based processing, a panoramic video acquisition guidance module 240 which includes or provides visual and/or audio-based video guidance indicators, and a video display 250. Note that the panoramic video image capture device 200 may comprise many additional components, modules, subsystems, etc., without departing from the spirit of the present invention.

In one implementation, the panoramic video acquisition guidance module 240 provides one or more panoramic video acquisition guidance indicators as described herein. Depending on the indicator, the panoramic video acquisition guidance module may (for instance) reference or employ, for example, the one or more video processing related components or the video image processing, as described further below.

As noted, panoramic video acquisition guidance module 240 may conceptually comprise different acquisition modules providing different guidance indicators. These modules may include a video rotation progress module, a video tilt and/or pitch status module, and/or a video rotation speed module.

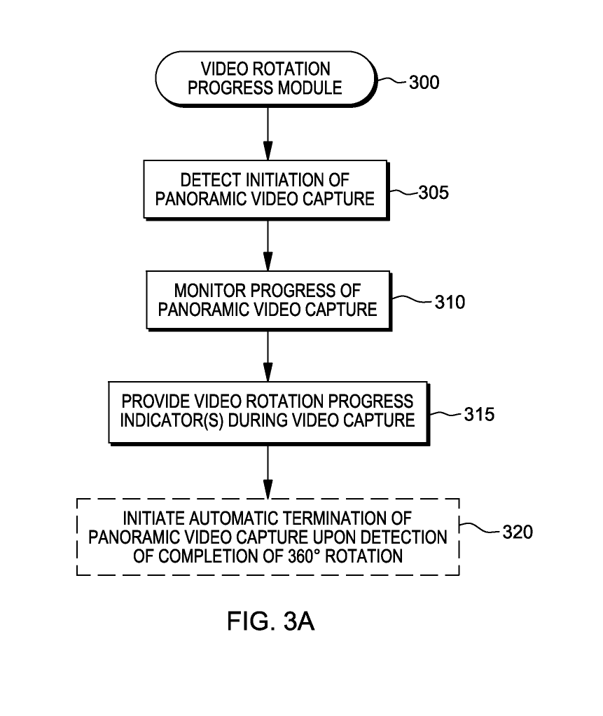

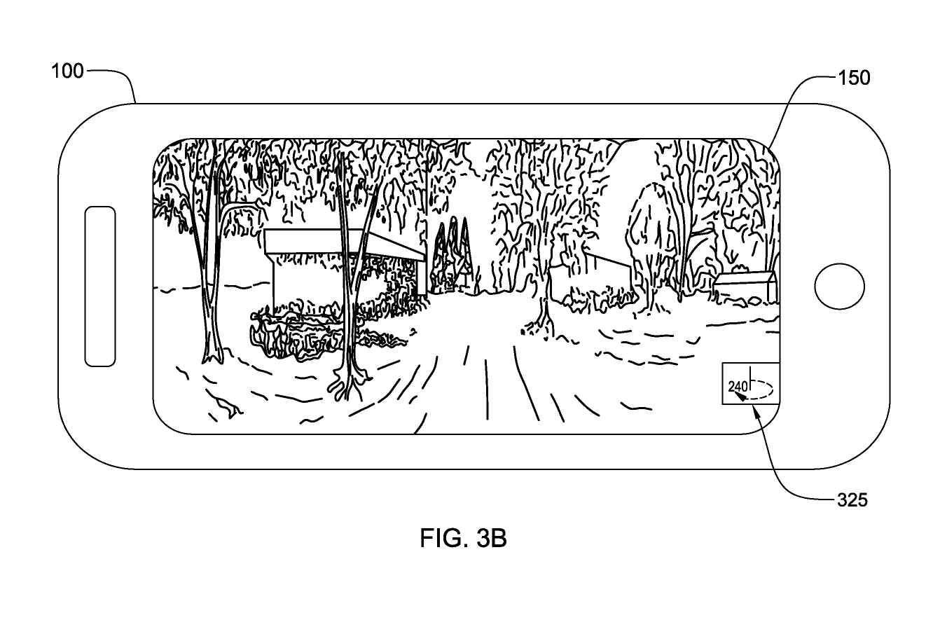

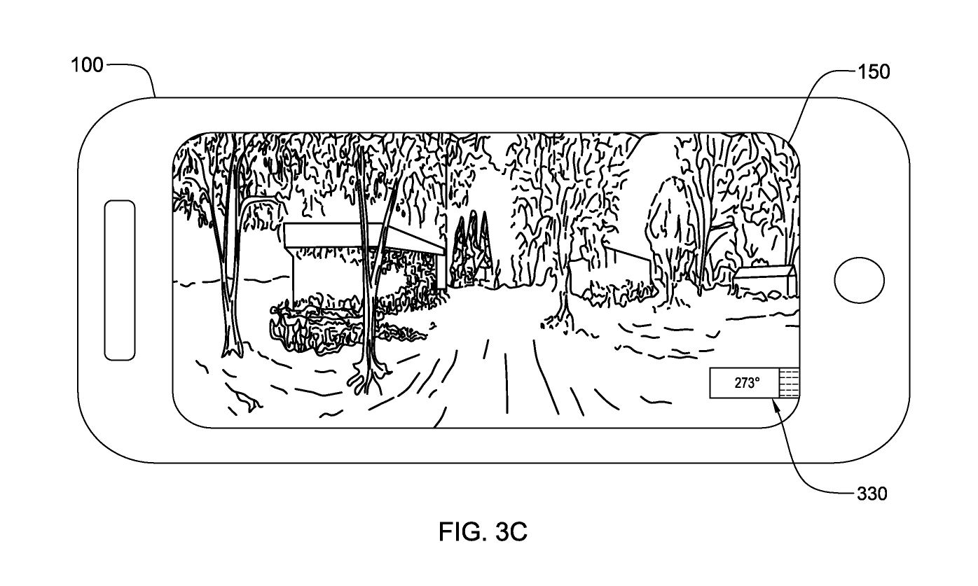

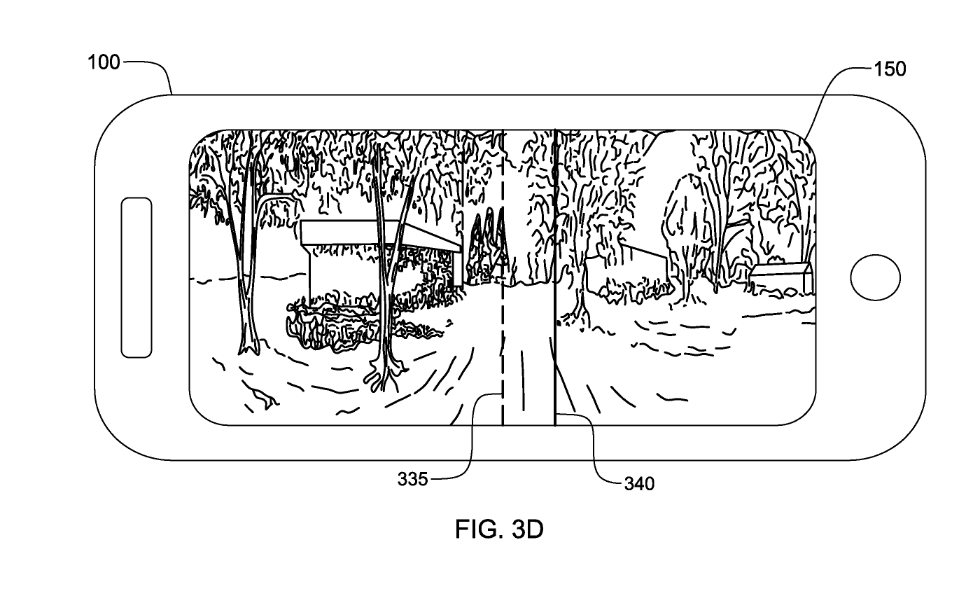

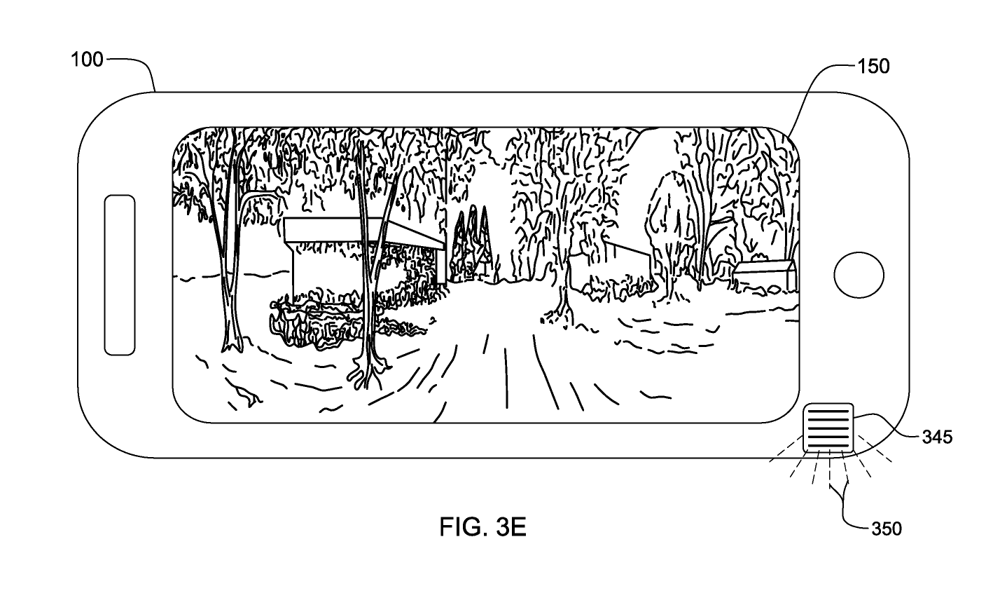

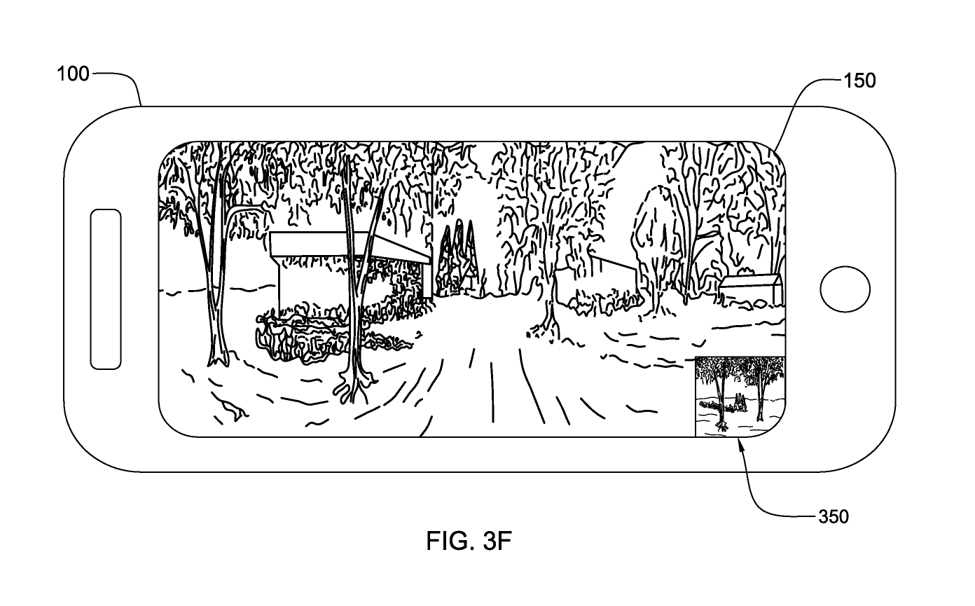

FIG. 3A depicts one embodiment of processing implemented by a video rotation progress module 300. This processing includes automatically detecting initiation of a panoramic video capture 305, and monitoring progress of the panoramic video capture 310. In one embodiment, automatically detecting initiation of a panoramic video capture may comprise detecting receipt or recording of a panoramic video by the associated video capture device, and monitoring progress of the panoramic video capture may employ a gyroscope and/or a compass, or for a 360° panorama, may involve image feature matching, edge image alignment, and/or other image alignment processes. While monitoring progress of the panoramic video capture, one and/or more video rotation progress indicators 315 may be provided in real-time, commensurate with the panoramic video capture.

As an optional feature, panoramic video capture may be automatically stopped based on detecting completion of a desired degree of rotation. In one example, the desired panorama may be a 360° panorama, with the video rotation progress module automatically terminating capture of video upon completion of a full 360° rotation. As an extension of this facility, the video capture device could be programmable by an operator to designate any degree of capture, such as, for example, a 180° panoramic video capture, a 240° degree panoramic video capture, etc., after which panoramic video capture may automatically terminate.

FIGS. 3B-3F depict various examples of video rotation progress indicators, in accordance with one or more aspects of the present invention.

In FIG. 3B, a video capture device 100 is illustrated with a video display 150 having, for example, a video rotation progress indicator 325 as a graphical overlay. This indicator is representative of the video rotation progress made since initiation of the panoramic video capture. In one embodiment, the video rotation progress indicator 325 changes substantially in real-time, with rotation of the video capture device 100 during capture of the panoramic video.

In FIG. 3C, video display 150 of video capture device 100 is provided with a progress bar-type, video rotation progress indicator 330. In one embodiment, the progress bar may move with rotation from 0°, up to 360°, and graphically depict the extent of the rotation completed, and possibly remaining uncompleted relative to, for example, a 360° rotation.

In FIG. 3D, the panoramic video guidance indicator illustrated comprises, by way of example, a fixed starting line 335 and a moving, starting line 340 locked, for example, on a point or edge of an initial frame of the panoramic video. For example, when a panorama video is captured clockwise, line 340 may move to the left, while if the panoramic video is captured counterclockwise, line 340 may move to the right. Line 340 will disappear when reaching the boarder of display screen 150, and come back onto the display screen from the other side. A full 360° panorama is captured when the moving line 340 again aligns over fixed line 335. Note that this indicator approach is particularly useful in capturing 360° panoramic videos.

FIG. 3E depicts an alternate embodiment of a video capture device 100 with a display screen 150 and one or more speakers 345 through which an audio-based panoramic video guidance indicator 350 is provided. For instance, this audio indicator might comprise, an audio signal that changes pitch the closer the operator reaches to the end of the desired rotation, or an audio signal indicating the end of the desired rotation or, by default, the end of a 360° rotation.

In FIG. 3F, a further panoramic video guidance indicator implementation is provided, wherein a thumbnail depiction 350 of an initially captured frame of video may overlie a portion of display window 150 of video capture device 100. In operation, an operator would reference the thumbnail to determine, for instance, when a desired 360° panoramic video capture has completed.

Note that one or more of the above-discussed video rotation progress indicators may be employed, either alone or in combination. For example, a video-based rotation progress indicator may be provided, along with an audio-based rotation progress indicator to provide the user with additional acquisition guidance during the panoramic video capture.

Establishing the panoramic video guidance indicators described herein, such as the video rotation progress indicator, may be readily implemented by one skilled in the art, and may be embodied (for instance) in software, hardware, or a combination thereof. Providing the progress indicator may involve using, if available in hardware, a gyroscope and/or a compass, in ascertaining the degree of rotation. Alternatively, for 360° panoramic video capture, image-based processing methods, such as image feature matching, edge image alignment, and/or other image alignment processes, may be employed.

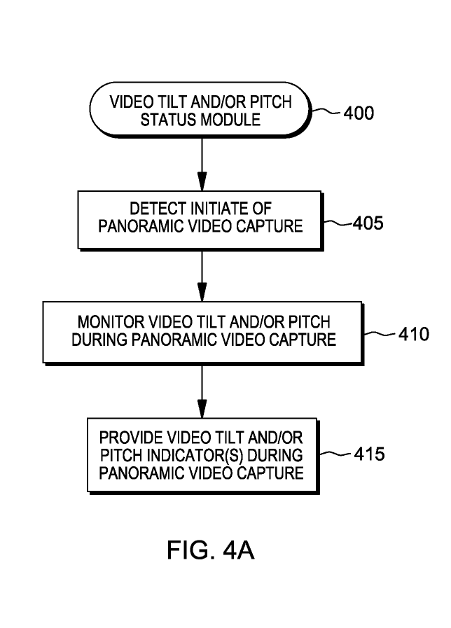

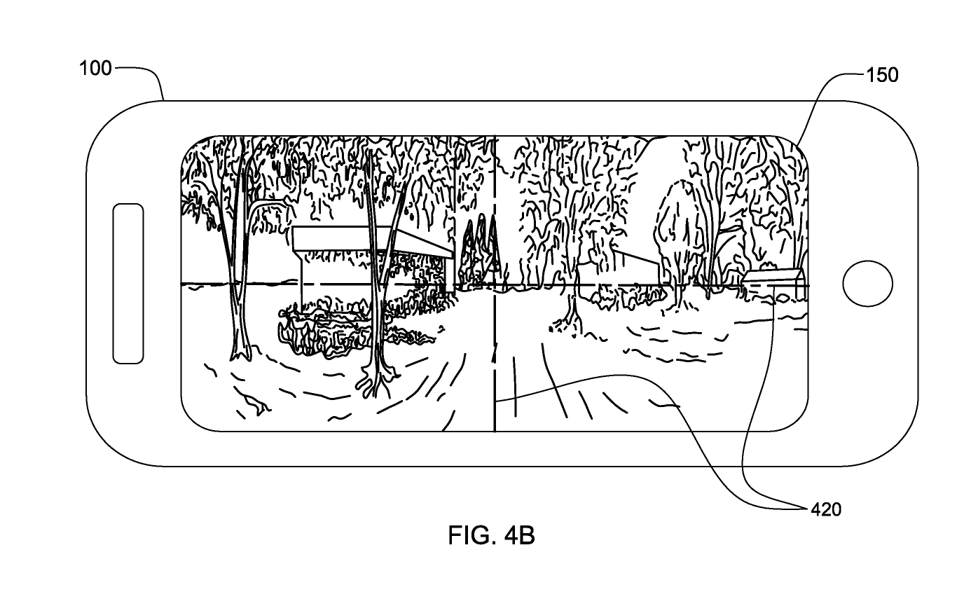

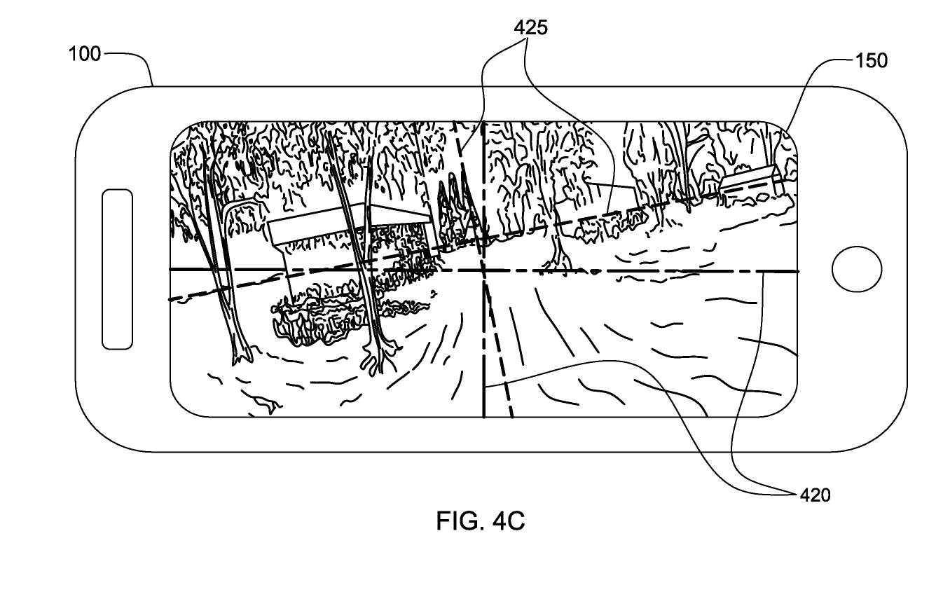

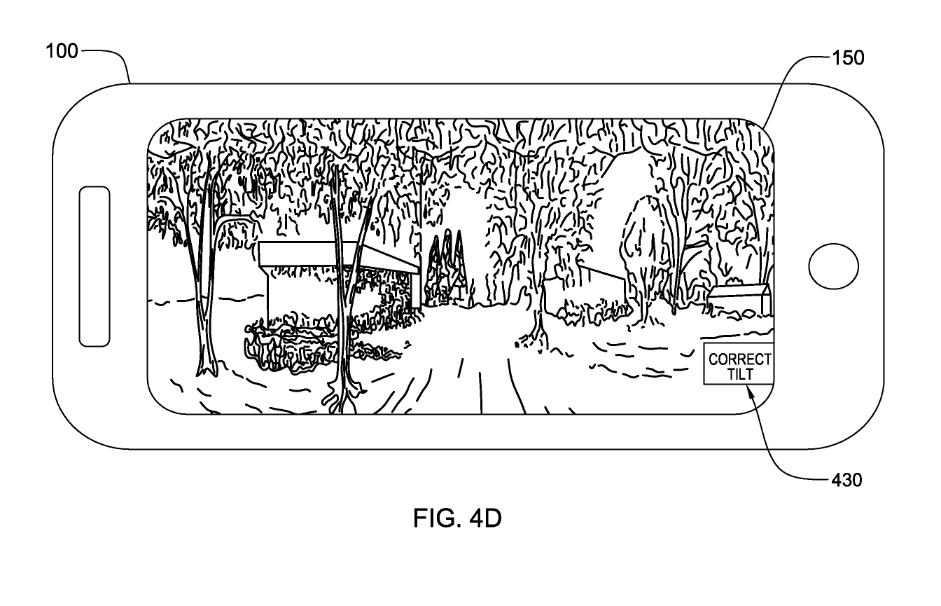

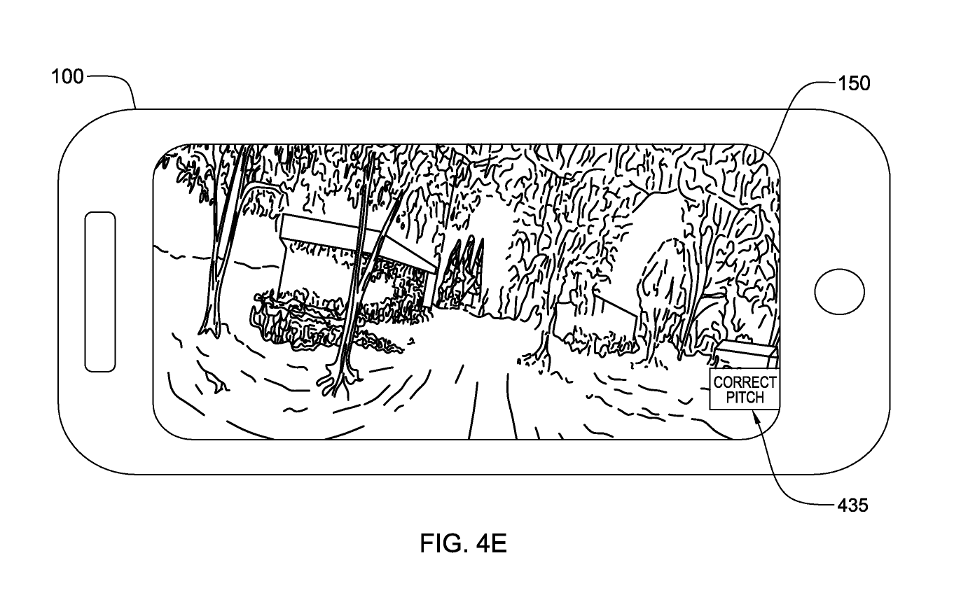

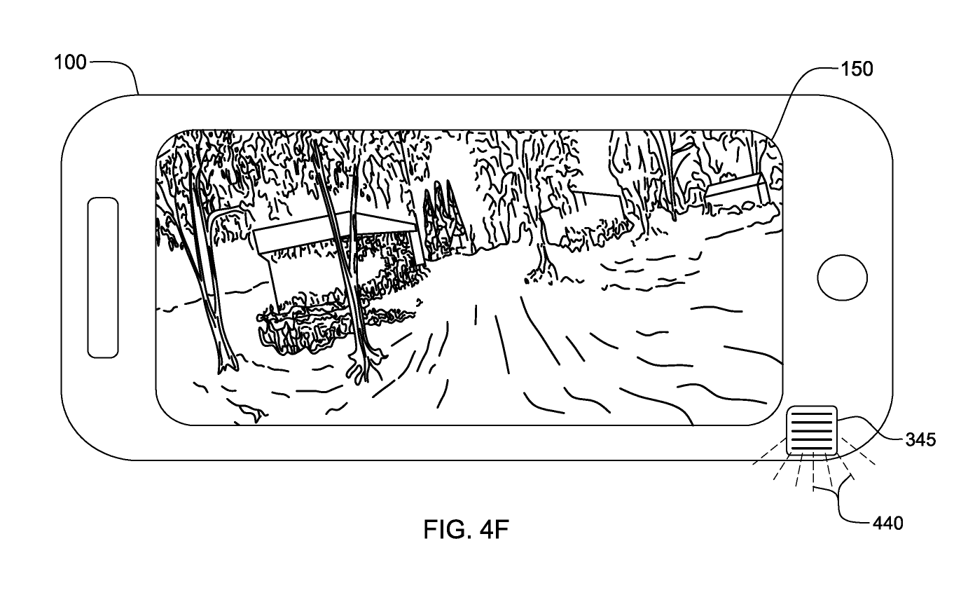

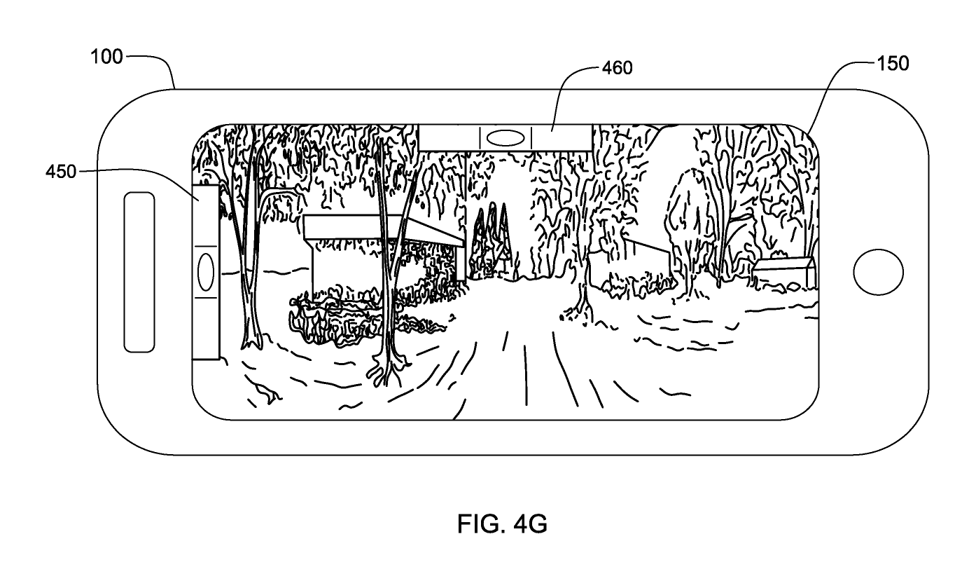

FIG. 4A depicts one embodiment of processing implemented by a video tilt and/or pitch status module 400. This processing includes, for instance, automatically detecting initiation of panoramic video capture through, for example, a rotation of the video capture device during video capture. Upon detection of panoramic video capture, the processing monitors for video tilt and/or video pitch during the panoramic video capture 410 and provides a video tilt and/or a video pitch indicator(s) in real-time, commensurate with the panoramic video capture 415.

As noted with respect to the video rotation progress indicator, one skilled in the art may readily establish a video tilt and/or video pitch indicator such as disclosed herein using, for instance, hardware-based processing, software-based processing, or a combination thereof. For example, if available in hardware on the video capture device, the tilt or pitch indicator(s) may utilize gyroscope-based, and/or accelerometer-based readings. Alternatively, image-based processing may be employed to ascertain tilt and/or pitch using, for example, motion tracking, horizon detection, etc.

FIGS. 4B-4G depict various examples of tilt and/or pitch status indicators, which may be provided in real-time to an operator or user during panoramic video capture.

In FIG. 4B, video capture device 100 is shown to comprise an x and a y axis overlay 420 on display screen 150. This overlay may be dynamically generated in comparison to, for example, an initially-captured frame of the video, and/or to a horizon of the panoramic video being captured.

In FIG. 4C, video displayed in display screen 150 of video capture device 100 is assumed to have a tilt and pitch 425 offset from the original (or desired) reference axes 420. In one embodiment, the tilt and pitch offset may be significant and unwanted upon completing a 360° panoramic video capture. In such a case, it would be desirable to align the tilt and pitch of the final video frame to match, for instance, that of the initial video frame of the panorama, with the indicator 425 providing the operator or user with a visual feedback to better align the beginning and ending frames of video.

An alternate implementation of this indicator is depicted in FIGS. 4D & 4E, wherein a graphical overlay 430, 435, respectively, is provided within display window 150 of video capture device 100, depending upon whether the acquisition guidance module detects a tilt misalignment (FIG. 4D), or a pitch misalignment (FIG. 4E), or both.

In FIG. 4F, an alternate implementation is depicted wherein video capture device 100 is provided with an audio panoramic video guidance indicator 440 indicative of tilt and/or pitch status of the current video being captured and shown, for example, within display window 150. This audio indicator 440 can be provided via one or more speakers 345 of video capture device 100. As one example, an audio indication can be provided which changes volume, frequency, tone, etc., with tilt and/or pitch varying from an intended, initial or otherwise desired tilt or pitch.

FIG. 4G depicts a further embodiment of a video capture device 100 with a pitch level indicator 450 and a tilt level indicator 460 superimposed over the live, current video image being captured and displayed within display window 150. These indicators provide the operator with real-time feedback on the pitch and tilt, respectively, of the video capture device employed in capturing the panoramic video.

As a further embodiment, the video rotation progress indicator described above in connection with FIGS. 3A-3F and/or the video tilt or pitch status indicators described above in connection with FIGS. 4A-4G could be provided by superimposing an overlay or phantom image depicting, for example, an initially-captured frame of video representative of image position, tilt and pitch at the start of the panoramic video capture. In one embodiment, edges may be extracted from an initial image to represent correct video position, tilt, and pitch upon completion, for instance of a 360° rotation. In another embodiment, alpha-banding could be employed in overlaying the initially captured frame of video as a phantom image over the current or live image of the video illustrated in the display window of the video capture device. In either embodiment, an operator could reference the overlay or phantom image to determine the desired tilt and/or pitch of the panoramic video being captured, as well as completion of a full 360° rotation.

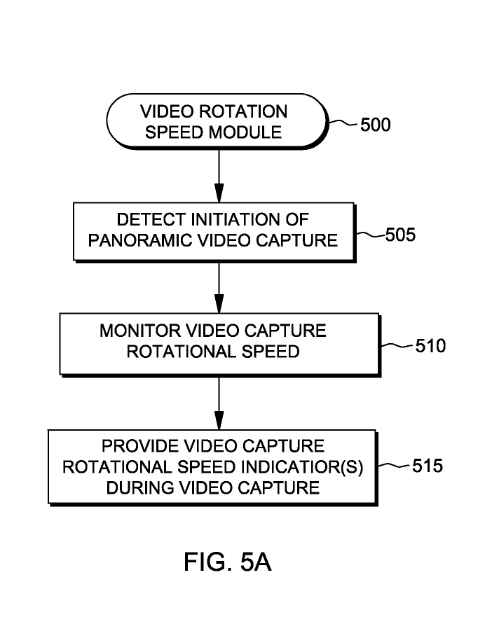

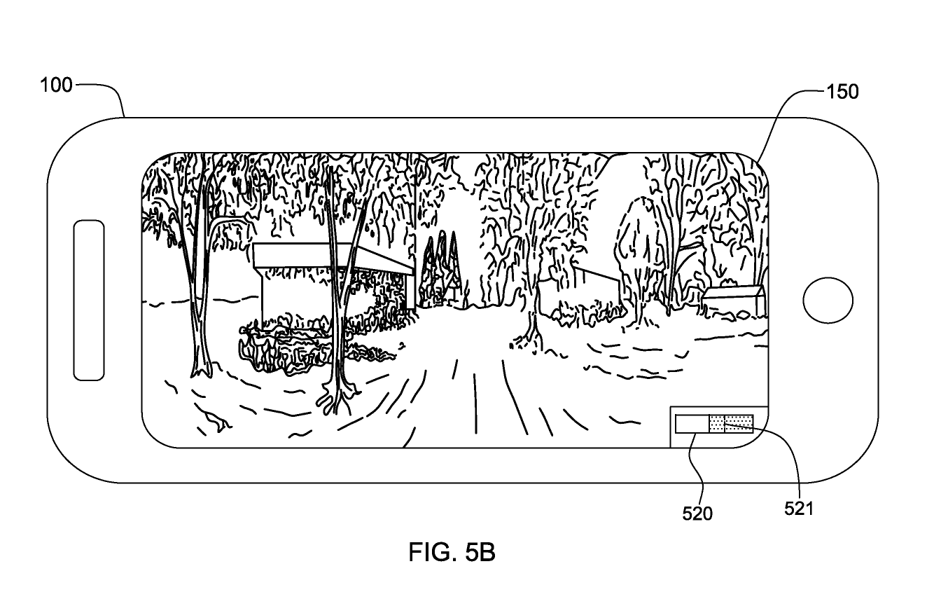

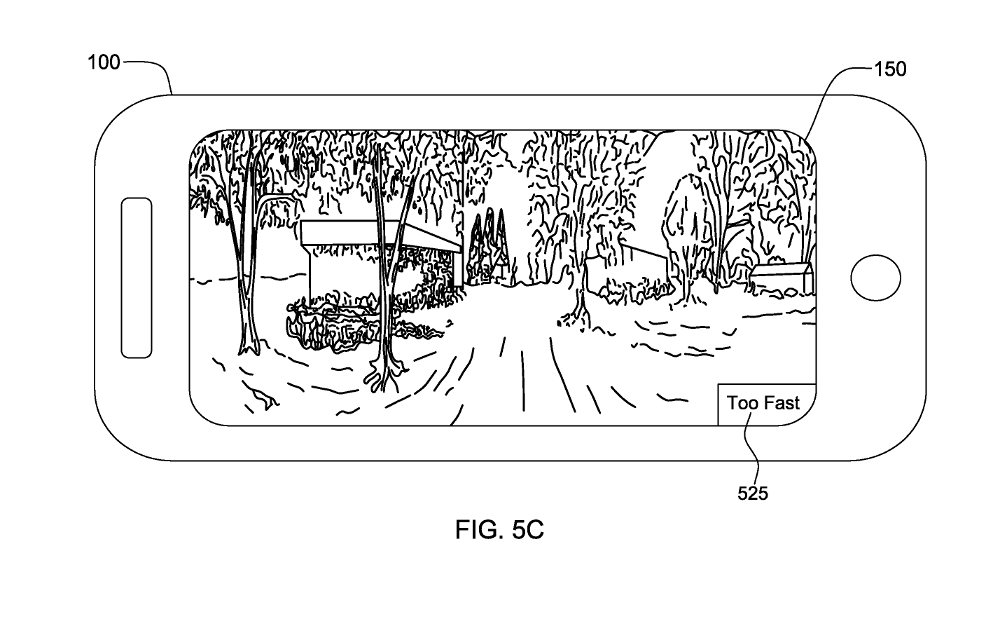

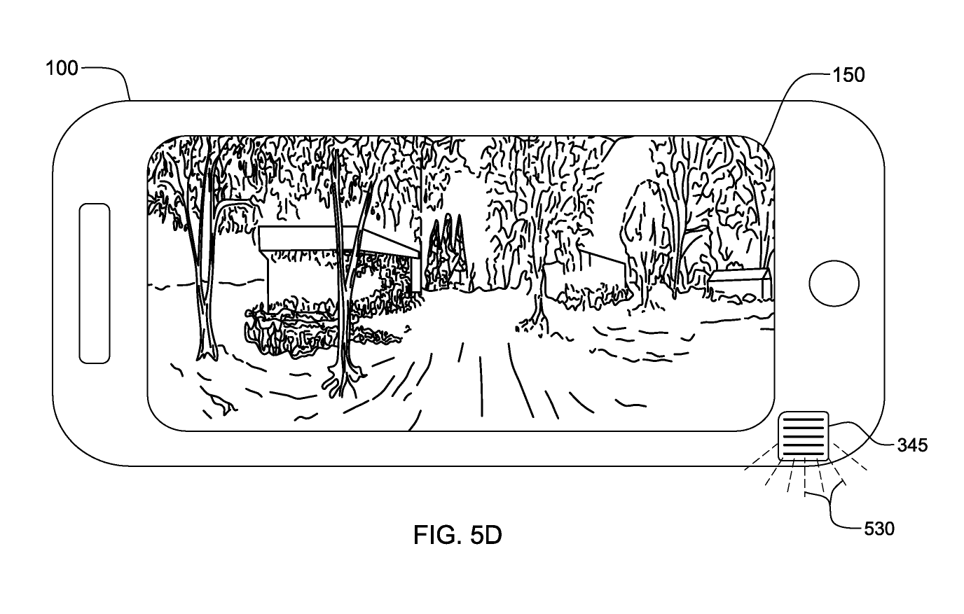

FIG. 5A depicts one embodiment of a video rotation speed module 500 which includes automatically detecting initiation of panoramic video capture 505, and monitoring the video capture rotational speed 510 via, for example, a gyroscope reading, an accelerometer reading, a magnetometer and/or compass reading, and/or by image-based processing, such as motion tracking. In one embodiment, depending on the panoramic video rotation speed, a video rotation speed indicator(s) may be provided during the video capture 515. FIGS. 5B-5D depict examples of this indicator.

In FIG. 5B, a video capture device 100 is illustrated with a display screen 150 over which an overlay 520 is provided, configured in this example as a rotational speed bar with, for instance, a maximum speed threshold 521, which if exceeded, changes color of the rotational speed bar from, for example, green to red, to provide the user with acquisition guidance to slow down the rotation of the video capture device.

In the example of FIG. 5C, the graphical overlay comprises a text message 525 displayed on video display 150 of video capture device 100. The actual text message may take various forms, depending upon the implementation.

In FIG. 5D, the panoramic video guidance indicator is an audio signal 530 provided via one or more speakers 345 of video capture device 100. In this example, a sound indication, or a verbal indication that the device is rotating too fast, may be provided to the user during capture of the panoramic video. Note that the audio signal may be employed in combination with a graphical overlay within display window 150, such as depicted in the examples of FIGS. 5B & 5C.

One of ordinary skill in the art may establish the rotation speed indicator, by way of example, using hardware-based processing, software-based processing, or a combination thereof. For example, if available in hardware, the rotational speed may be derived from a gyroscope reading, an accelerometer reading, a magnetometer and/or compass reading. Alternatively, image-based processing, such as motion tracking, may be employed to ascertain rotational speed. As a further embodiment, image analysis of the captured video may be employed, with detection of blurrying video being an indication that the rotational speed of the panoramic video capture is too high.

Aspects of the invention disclosed herein, or any part(s) or function(s) thereof, may be implemented using hardware, software modules, firmware, tangible computer-readable media having instructions stored thereon, or a combination thereof and may be implemented in one or more computer systems or other processing systems.

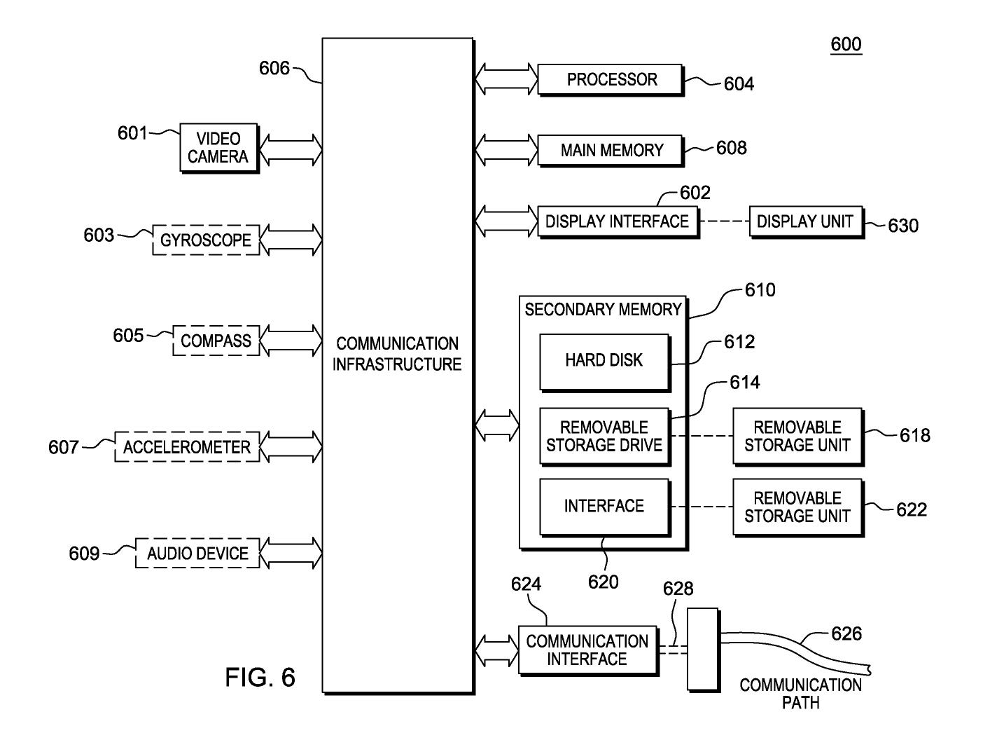

FIG. 6 illustrates an example computer system 600 in which embodiments of the present invention, or portions thereof, may be implemented (for instance) as computer-readable code. For example, the panoramic video capture device 200 of FIG. 2 can be implemented in computer system 600 using hardware, software, firmware, tangible computer-readable media having instructions stored thereon, or a combination thereof and may be implemented in one or more computer systems or other processing systems. Hardware, software, or any combination of such may embody any of the modules or components of FIGS. 1-5D. In the illustrated example of FIG. 6, computer system 600 includes a video camera 601 and optionally, one or more of a gyroscope 603, a compass 605, an accelerometer 607, or an audio device 609 (including, for instance, one or more speakers).

These components communicate via a communication infrastructure 606 with, for example, a display interface 602, one or more processor devices 604, a main memory 608, a secondary memory 610, and a communication interface 624.

If programmable logic is used, such logic may executed on a commercially available processing platform or a special purpose device. One of ordinary skill in the art may appreciate that embodiments of the disclosed subject matter can be practiced with various computer system configurations, including multi-core multiprocessor systems, mini-computers, mainframe computers, computers linked or clustered with distributed functions, as well as pervasive or miniature computers that may be embedded into virtually any device.

For instance, a processor device and a memory may be used to implement the above-described embodiments. The processor device may be a single processor, a plurality of processors, or combinations thereof, and a processor device may have one or more processor “cores”.

Various embodiments of the invention may be implemented in terms of the example computer system 600 of FIG. 6. After reading this description, it will be apparent to a person skilled in the relevant art how to implement the invention using available components, devices, computer systems, computer architectures, etc. Although operations may be described as a sequential process, some of the operations may in fact be performed in parallel, concurrently, and/or in a distributed embodiment, and with program code stored locally or remotely for access by single or multi-processor machines. In addition, in some embodiments, the order of operations may be rearranged without departing from the spirit of the disclosed subject matter.

Processor device 604 may be a special purpose or a general purpose processor device. As will be appreciated by persons skilled in the relevant art, processor device 602 may also be a single processor in a multi-core/multiprocessor system, such system operating alone, or in a cluster of computing devices operating in a cluster or server farm. Processor device 604 is connected to communication infrastructure 606, which includes, for example, a bus, message queue, network, or multi-core message-passing scheme.

Computer system 600 also includes main memory 608, for example, random access memory (RAM), and may also include secondary memory 610. Secondary memory 610 may include, for example, a hard disk drive 612 and a removable storage drive 614. Removable storage drive 614 may include a floppy disk drive, a magnetic tape drive, an optical disk drive, a flash memory, or the like. The removable storage drive 614 reads from and/or writes to a removable storage unit 618 in a well-known manner. Removable storage unit 618 may comprise a floppy disk, magnetic tape, optical disk, etc., which is read by and written to by removable storage drive 614. As will be appreciated by persons skilled in the relevant art, removable storage unit 618 includes a computer-usable storage medium having stored therein computer software and/or data.

In alternate implementation, secondary memory 610 may include other similar means for allowing computer programs or other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include communications interface 624. Communications interface 624 allows (for example) software and/or data to be transferred between computer system 600 and external devices. Communications interface 624 may include a modem, a network interface (such as an Ethernet card), a communications port, a peripheral card, or the like. Software and data transferred via communications interface 624 may be in the form of signals, which may be electronic, electromagnetic, optical, or other signals capable of being received by communications interface 624. These signals may be provided to communications interface 624 via a communications path 626. Communications path 626 carries signals and may be implemented using wire or cable, fiber optics, a phone line, a cellular phone link, an RF link, or other communications channels.

In this document, the terms “computer program medium” and “computer-usable medium” are used, for example, to generally refer to media such as removable storage unit 618, removable storage unit 622, and a hard disk installed in hard disk drive 612. Computer program medium and computer-usable medium may also refer to memories, such as main memory 608 and secondary memory 610, which may be memory semiconductors (e.g., DRAMs, etc.).

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor device 604 to implement the processes of the present invention, such as the stages in the methods discussed above. Accordingly, such computer programs represent controllers of the computer system 600. Where the invention is implemented using software, the software may be stored in a computer program product and loaded into computer system 600 using removable storage drive 614, interface 620, and hard disk drive 612, or communications interface 624.

Embodiments of the invention may also be directed to computer program products comprising software stored on any computer-usable medium. Such software, when executed in one or more data processing devices, causes a data processing device(s) to operate as described herein. Embodiments of the invention employ any computer-usable or readable medium. Examples of computer-usable mediums include, but are not limited to, primary storage devices (e.g., any type of random access memory), secondary storage devices (e.g., hard drives, floppy disks, CD ROMs, ZIP disks, tapes, magnetic storage devices, and optical storage devices, MEMs, nano-technological storage device, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A method comprising:
receiving a panoramic video being captured; and
providing at least one panoramic video acquisition guidance indicator, the at least one panoramic video acquisition guidance indicator comprising acquisition feedback on the panoramic video being captured, and being based, at least in part, on the panoramic video being captured or movement of a video capture device capturing the panoramic video.

2. The method of claim 1, wherein the providing comprises providing the at least one panoramic video acquisition guidance indicator in real-time, commensurate with capturing of the panoramic video.

3. The method of claim 1, wherein the at least one panoramic video acquisition guidance indicator comprises a video rotation progress indicator, the video rotation progress indicator being indicative of rotational progress of the panoramic video being captured or the video capture device capturing the panoramic video.

4. The method of claim 3, wherein the video rotation progress indicator comprises a visual indicator of rotational progress of the panoramic video being captured or the video capture device capturing the panoramic video.

5. The method of claim 4, wherein the visual indicator comprises one of a progress bar or a progress circle indicative of rotational progress of the panoramic video being captured, or the video capture device capturing the panoramic video, through a potential 360° video rotation, the visual indicator being provided commensurate with capturing of the panoramic video.

6. The method of claim 3, wherein the video rotation progress indicator comprises an audible indicator of rotational progress of the panoramic video being captured or the video capture device capturing the panoramic video, the audible indicator comprising an audible signal which varies as the panoramic video is captured relative to a potential 360° video rotation.

7. The method of claim 3, further comprising automatically stopping capturing of the panoramic video upon reaching a 360° video rotation.

8. The method of claim 3, wherein providing the video rotation progress indicator comprises establishing the video rotation progress indicator, the establishing being based, at least in part, on at least one of a gyroscope, a compass, or image-analysis.

9. The method of claim 3, wherein the video rotation progress indicator comprises a graphical overlay representative of an initial video frame of the panoramic video being captured or an initial position of the video capture device capturing the panoramic video.

10. The method of claim 1, wherein the at least one panoramic video acquisition guidance indicator comprises a video tilt or video pitch indicator, the video tilt or video pitch indicator being indicative of at least one of a tilt or a pitch of the panoramic video being captured or of the video capture device capturing the panoramic video.

11. The method of claim 10, wherein the video tilt or video pitch indicator comprises a visual indicator depicting at least one of a video tilt or a video pitch change compared with at least one prior video frame of the panoramic video being captured or a horizon of the panoramic video being captured.

12. The method of claim 10, wherein the video tilt or video pitch indicator comprises an audible indicator, the audible indicator varying with a change in at least one of tilt or pitch of the panoramic video being captured or the video capture device capturing the panoramic video.

13. The method of claim 10, wherein the providing further comprises establishing the video tilt or video pitch indicator, the establishing being based, at least in part, on at least one of a gyroscope, an accelerometer, or image-analysis.

14. The method of claim 1, wherein the at least one panoramic video acquisition guidance indicator comprises a video rotation speed indicator.

15. The method of claim 14, wherein the video rotation speed indicator comprises a visual indicator based on rotation speed of the panoramic video being captured or the video capture device capturing the panoramic video.

16. The method of claim 14, wherein the video rotation speed indicator comprises an audible indicator, the audible indicator being based on rotation speed of the panoramic video being captured or the video capture device capturing the panoramic video.

17. The method of claim 14, wherein the providing further comprises establishing the video rotation speed indicator, the establishing being based, at least in part, on at least one of a gyroscope, an accelerometer, or image-analysis.

18. A method comprising:
receiving a panoramic video being captured;
providing, based at least in part on the panoramic video being captured or movement of a video capture device capturing the panoramic video, at least one panoramic video acquisition guidance indicator commensurate with capturing of the panoramic video, the at least one panoramic video acquisition guidance indicator providing feedback on the panoramic video being captured; and
wherein the at least one panoramic video acquisition guidance indicator comprises at least one of a video rotation progress indicator, a video tilt or video pitch indicator, or a video rotation speed indicator.

19. A system comprising:
a video capture device; and
a panoramic video acquisition guidance component associated with the video capture device, the panoramic video acquisition guidance component providing at least one panoramic video acquisition guidance indicator, based at least in part on a panoramic video being captured by the video capture device or movement of the video capture device during capturing of the panoramic video, the at least one panoramic video acquisition guidance indicator comprising panoramic video acquisition guidance on the panoramic video being captured.

20. The system of claim 19, wherein the panoramic video acquisition guidance component provides the at least one panoramic video acquisition guidance indicator in real-time, commensurate with capturing of the panoramic video by the video capture device.

21. The system of claim 19, wherein the at least one panoramic video acquisition guidance indicator comprises a video rotation progress indicator, the video rotation progress indicator being indicative of rotational progress of the panoramic video being captured or the video capture device capturing the panoramic video.

22. The system of claim 21, wherein the panoramic video acquisition guidance component automatically stops capturing of the panoramic video by the video capture device upon reaching a set video rotation.

23. The system of claim 19, wherein the at least one panoramic video acquisition guidance indicator comprises a video tilt or video pitch indicator, the video tilt or video pitch indicator being indicative of at least one of a tilt or a pitch of the panoramic video being captured or the video capture device capturing the panoramic video.

24. The system of claim 19, wherein the at least one panoramic video acquisition guidance indicator comprises a video rotation speed indicator based on rotation speed of the panoramic video being captured or the video capture device capturing the panoramic video.

25. A system comprising:
a video capture device; and
a panoramic video acquisition guidance component associated with the video capture device, the panoramic video acquisition guidance component providing at least one panoramic video acquisition guidance indicator based at least in part on, and commensurate with, capturing of a panoramic video via the video capture device, the at least one panoramic video acquisition guidance indicator comprising panoramic video acquisition guidance on the panoramic video being captured, and comprising at least one of a video rotation progress indicator, a video tilt or video pitch indicator, or a video rotation speed indicator.

26. A computer program product for guiding panoramic video acquisition, the computer program product comprising:
a computer-readable storage medium readable by a processor and storing instructions for execution by the processor for performing a method comprising:
receiving a panoramic video being captured; and
providing at least one panoramic video acquisition guidance indicator, the at least one panoramic video acquisition guidance indicator comprising acquisition feedback on the panoramic video being captured, and being based, at least in part, on the panoramic video being captured or movement of a video capture device capturing the panoramic video.

27. The computer program product of claim 26, wherein the providing comprises providing the at least one panoramic video acquisition guidance indicator in real-time, commensurate with capturing of the panoramic video.

28. The computer program product of claim 26, wherein the at least one panoramic video acquisition guidance indicator comprises a video rotation progress indicator, the video rotation progress indicator being indicative of rotational progress of the panoramic video being captured or the video capture device capturing the panoramic video.

29. The computer program product of claim 28, further comprising automatically stopping capturing of the panoramic video upon reaching a set video rotation.

30. The computer program product of claim 26, wherein the at least one panoramic video acquisition guidance indicator comprises a video tilt or video pitch indicator, the video tilt or video pitch indicator being indicative of at least one of a tilt or a pitch of the panoramic video being captured or the video capture device capturing the panoramic video.

31. The computer program product of claim 26, wherein the at least one panoramic video guidance indicator comprises a video rotation speed indicator.
